(19) United States
(12) Patent Application Publication
(10) Pub. No.: US 2026/0021959 A1
(43) Pub. Date: Jan. 22, 2026

(54) PORTABLE BAG DISPENSER UNIT

(71) Applicant: ANGELCARE CANADA INC., Montreal (CA)

(72) Inventors: Jack MARPLE, Oakland, CA (US); Carly KIM, Oakland, CA (US); Luis VELAZQUEZ, Oakland, CA (US); Hannah SUN, Oakland, CA (US); Nathanael GONZALEZ, Oakland, CA (US)

(21) Appl. No.: 19/273,364

(22) Filed: Jul. 18, 2025

Related U.S. Application Data
(60) Provisional application No. 63/673,286, filed on Jul. 19, 2024.

(51) Int. Cl. B65F 1/14; F16M 13/02

(52) U.S. Cl. CPC B65F 1/1426; F16M 13/02; B65F 2240/136

(57) ABSTRACT

A bag dispenser unit for dispensing bags is presented, with a casing having a front casing portion mounted to a rear casing portion to define an inner cavity therewithin for receiving a bag roll. The rear casing portion includes a pair of axially-aligned bag roll axles along a bag roll axis for engaging an interior of the bag roll, the bag roll rotatable about the bag roll axis. An opening is defined through the front casing portion for outletting a free end of the bag roll to dispense the bags. A holder is operatively coupled to the casing.

### CROSS-REFERENCE TO RELATED APPLICATION

The present application claims the priority of U.S. Patent Application No. 63/673,286, filed on Jul. 19, 2024, the content of which is incorporated herein by reference.

### FIELD OF THE APPLICATION

The present application relates to a portable bag dispenser unit supporting a plurality of bags for the dispensing thereof, known as dog poop bags.

### BACKGROUND OF THE ART

In various circumstances, there is often a need to carry bags in order to dispose of odorous waste. For example, because of municipal regulations, dog waste must be picked up by the guardian of the dog. In another example, it may occur that diapers with feces must be disposed of, away from diaper disposal systems. However, by simply throwing waste with feces into typical garbage cans, the odors emanating from the waste will hardly be bearable over time. It is therefore desired to sealingly wrap or bag such odorous waste items individually to prevent this problem.

In some instances, bags for diaper disposal systems use types of polymers having specific airtightness characteristics, to retain the odors in the sealed bag. One copolymer commonly used for this purpose is an ethylene vinyl alcohol copolymer (also known as EVOH). However, such polymers are relatively expensive, whereby their use must be maximized.

Dispensing devices and bag rolls therefore have been devised to dispense single-use bags to collect waste. However, known dispensing devices may be hard to manipulate, and may expose the bag rolls to child maneuvers and to the elements.

### SUMMARY

It is a feature of the present disclosure to provide a novel bag dispenser unit.

It is another feature of the present disclosure to provide a novel method for dispensing bags from a bag dispenser unit.

It is another feature of the present disclosure to provide a novel method for installing bag rolls into a bag dispenser unit.

Therefore, in accordance with a first aspect, there is provided a bag dispenser unit for dispensing bags, comprising: a casing having a front casing portion mounted to a rear casing portion to define an inner cavity therewithin for receiving a bag roll, the rear casing portion including a pair of axially-aligned bag roll axles along a bag roll axis for engaging an interior of the bag roll, the bag roll rotatable about the bag roll axis, an opening defined through the front casing portion for outletting a free end of the bag roll to dispense the bags; and a holder operatively coupled to the casing.

Further in accordance with the first aspect, for instance, the bag dispenser unit further includes a strap operatively coupled to the casing at a first strap end and having a fastener disposed at a second strap end.

Still further in accordance with the first aspect, for instance, the fastener is a snap fastener.

Still further in accordance with the first aspect, for instance, the casing is operatively couplable to a pet leash.

Still further in accordance with the first aspect, for instance, the strap is configured to engage a ring on the pet leash and the holder is configured to retain the casing against the pet leash.

Still further in accordance with the first aspect, for instance, the strap is integrally formed with the holder.

Still further in accordance with the first aspect, for instance, the opening extends at least partially across a top surface of the front casing portion to at least partially expose the bag roll inside the inner cavity.

Still further in accordance with the first aspect, for instance, the front casing portion is hingedly mounted to the rear casing portion.

Still further in accordance with the first aspect, for instance, the holder is removably attachable to the front casing portion on a first side of the bag dispenser unit and to the rear casing portion on a second side of the bag dispenser unit opposite the first side.

Still further in accordance with the first aspect, for instance, the bag dispenser unit further includes a rear cover removable attachable to the holder.

Still further in accordance with the first aspect, for instance, the rear cover includes posts protruding from a surface thereof, the posts alignable and insertable through corresponding holes through a body of the holder and a body of the rear casing portion.

Still further in accordance with the first aspect, for instance, the holder includes a tab having a first end coupled to an edge of the holder at a first side of the bag dispenser unit and a second end coupleable to the rear casing portion at a second end of the bag dispenser unit to form a loop at a rear of the bag dispenser unit.

In accordance with a second aspect, there is provided a method for dispensing bags from a bag dispenser unit, comprising: grasping a bag from a bag roll inside the bag dispenser unit via an opening of the bag dispenser unit, the opening extending across an outer surface of the bag dispenser unit and configured for allowing visual inspection of the bag roll inside the bag dispenser unit; pulling the bag out of the bag dispenser unit to unroll the bag from the bag roll; and detaching the bag from the bag roll.

Further in accordance with the second aspect, for instance, the method further includes unfolding the bag from a folded condition.

Still further in accordance with the second aspect, for instance, inserting a hand in the bag and picking up waste with the hand shielded by the bag.

Still further in accordance with the second aspect, for instance, the method further includes removing the hand from the bag and tuning the bag inside out for the waste to be captured in the inside out bag.

Still further in accordance with the second aspect, for instance, the method further includes visually inspecting the inside of the bag dispenser unit, via the opening of the bag dispenser unit, to determine a number of bags remaining on the bag roll.

Still further in accordance with the second aspect, for instance, the method further includes disengaging a front casing portion of the bag dispenser unit from a rear casing portion of the bag dispenser unit; inserting the bag roll within the bag dispenser unit by engaging the bag roll with a bag roll axles of the rear casing portion; and engaging the front casing portion to the rear casing portion.

Still further in accordance with the second aspect, for instance, disengaging the front casing portion from the rear casing portion and engaging the front casing portion to the rear casing portion each include pivoting the front casing portion relative to the rear casing portion about a hinge axis defined through a hinged connection between the front casing portion and the rear casing portion.

Still further in accordance with the second aspect, for instance, the method further includes securing the bag dispenser unit to a leash by securing a strap operatively coupled to the bag dispenser unit to a ring on the leash.

Still further in accordance with the second aspect, for instance, the method further includes, subsequently to detaching the bag from the bag roll, inserting a free end of the bag roll through the opening.

### BRIEF DESCRIPTION OF DRAWINGS

FIGS. 1A-1C are front, front perspective and rear perspective views, respectively, of a portable bag dispenser unit in accordance with an embodiment of the present disclosure;

FIG. 2 is an exploded view of the portable bag dispenser unit of FIG. 1, with a bag roll;

FIGS. 3A-3D are perspective views showing a sequence of securing the portable bag dispenser unit of FIG. 1 to a leash;

FIGS. 4A-4H are perspective views showing a sequence of installing an exemplary bag roll into the portable bag dispenser unit of FIG. 1;

FIG. 5 is an enhanced front perspective view of the portable bag dispenser unit of FIG. 1;

FIG. 6 is an enhanced top perspective view of the portable bag dispenser unit of FIG. 1;

FIG. 7 is a front perspective view of a portable bag dispenser unit in accordance with another embodiment of the present disclosure;

FIG. 8 is a schematic view of an exemplary bag roll that may be used with the portable bag dispenser unit of FIGS. 1 and 7;

FIG. 9 is a schematic view of a pair of bags of the bag roll of FIG. 8;

FIGS. 10A-10C are front, front perspective and rear perspective views, respectively, of a portable bag dispenser unit in accordance with another embodiment of the present disclosure;

FIG. 11 is an exploded view of the portable bag dispenser unit of FIG. 10;

FIGS. 12A-12F are perspective views showing a sequence of assembling the portable bag dispenser unit of FIG. 10;

FIGS. 13A-13B are side and enhanced side views, respectively, of the portable bag dispenser unit of FIG. 10;

FIG. 14 is an enhanced perspective view of a partially assembled portable bag dispenser unit of FIG. 10; and

FIGS. 15A-15C are perspective views showing a sequence of assembling a holder to the portable bag dispenser unit of FIG. 10.

### DETAILED DESCRIPTION

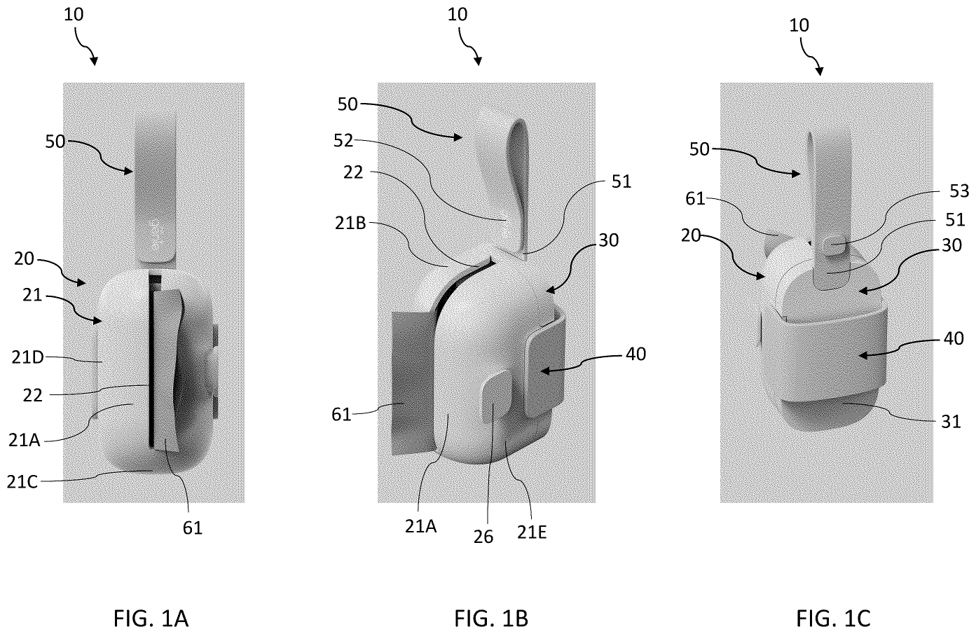

Referring to the drawings and, more particularly to FIGS. 1A-1C, there is illustrated a portable bag dispenser unit 10 that is used to dispense bags, such as bags from a bag roll. The portable bag dispenser unit 10 is said to be portable, in that it is relatively small and lightweight, and may have an attachment feature.

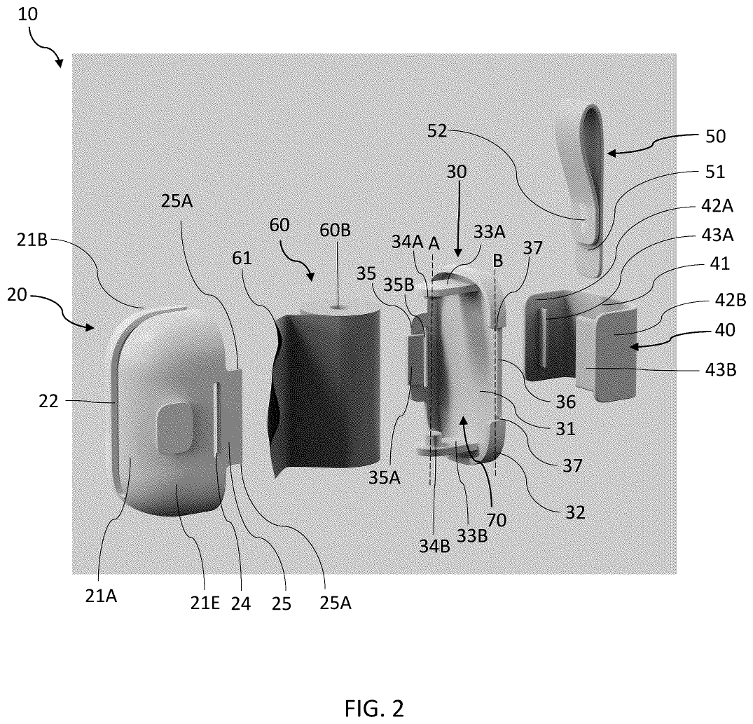

Referring concurrently to FIGS. 1A-1C and 2, the bag dispenser unit 10 is shown having a casing defined by a front casing portion 20 and a rear casing portion 30, a holder 40 and an attachment 50. In some embodiments, the attachment 50 may be omitted. The front and rear casing portions 20, 30 cooperate to define the casing to accommodate a bag roll 60. The front casing portion 20 is hingedly mounted to the rear casing portion 30 to enable access to a hollow inner cavity 70 formed between the front casing portion 20 and rear casing portion 30. The front casing portion 20 and rear casing portion 30 may be collectively referred to as the casing of the bag dispenser unit 10. Referring to FIGS. 1A-1C and 2, the inner cavity 70 is sized so as to accommodate a bag roll 60. In an embodiment, the front casing portion 20 is releasably interconnected with the rear casing portion 30 so as to provide access to the inner cavity 70 to optionally insert a bag roll 60 into the bag dispenser unit 10. According to an embodiment, the front and rear casing portions 20, 30 are made of a plastic material with greater rigidity (e.g., a plastomer), while the holder 40 and attachment 50 are made of a plastic material with greater flexibility (e.g., an elastomer such as silicone rubber). Any other appropriate materials are also considered.

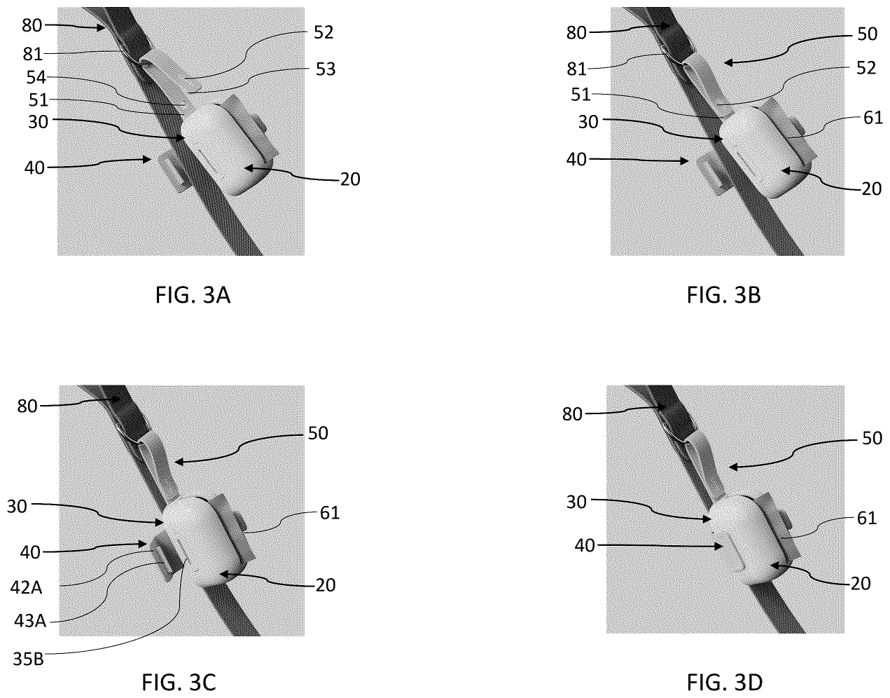

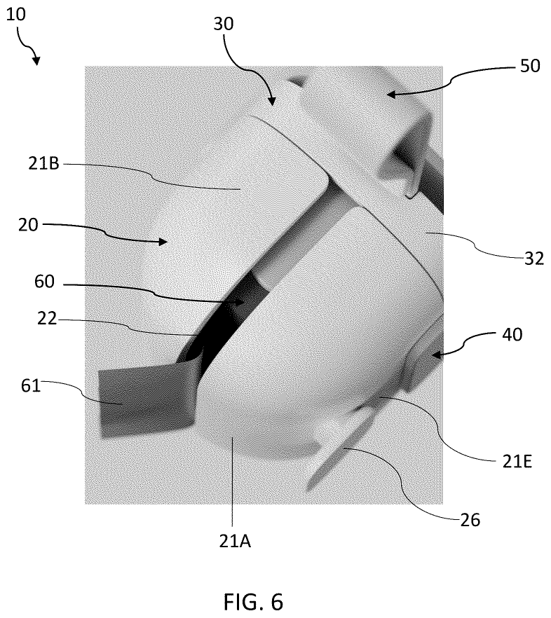

As shown in FIGS. 1A-1C, the front casing portion 20 has a body 21 with a front 21A, top 21B, bottom 21C, first side 21D and second side 21E, the body 21 for instance being bulbous. While the front casing portion 20 is described as having 21A, 21B, 21C, 21D and 21E, its surface may be continuous, i.e., edgeless, between such faces or sides, as illustrated in FIGS. 1A-1C. A rear of the body 21 is open so as to engage with the rear casing portion 30. The front casing portion 20 has a dispensing opening 22 defined therein. Illustratively, the dispensing opening 22 has a slit-like shape extending across two faces of the body 21, the front 21A and top 21B, in a generally longitudinal direction, but it could be limited to a single face or may be more than two faces. If the dispensing opening 22 is a slit, it may be said that it lies in a plane concurrently with the bag roll axis A. If the dispensing opening 22 is a slit, it may be said that it is parallel to the bag roll axis A and/or the hinge axis B. Stated differently, it may be one or both of the long edges of the slit 22, or a midline, that may be coplanar and/or parallel as described above. Moreover, when the bag dispensing unit 10 is seated on its bottom face, such plane in which lies the slit 22 and the bal roll axis A and/or the hinge axis B (or to which they are parallel), is perpendicular to the ground. This applies to any other embodiment of the bag dispensing unit described herein. In the shown case, the dispensing opening 22 is aligned with a leash 80 when the dispensing unit is attached to the leash 80 (see FIGS. 3A-3D). Other appropriate shapes may be used for the dispensing opening 22. It is considered to shape the opening 22 with ornamental outlines. As observed from FIGS. 1A-1B, the opening 22 is a relatively narrow opening, i.e., wide enough to allow individual bags of the bag roll 60 to pass therethrough but narrow enough to prevent the bag roll 60 itself from passing therethrough. The depicted opening 22 generally bisects the front 21A, although non-symmetrical locations for the opening 22 may be contemplated. The depicted opening 22 optionally extends from an uppermost portion of the top 21B and terminates at a lower end of the front 21A. As such, the opening 22 may provide a view inside the inner cavity 70 and of the bag roll 60 (see FIG. 6), as will be discussed in further detail below.

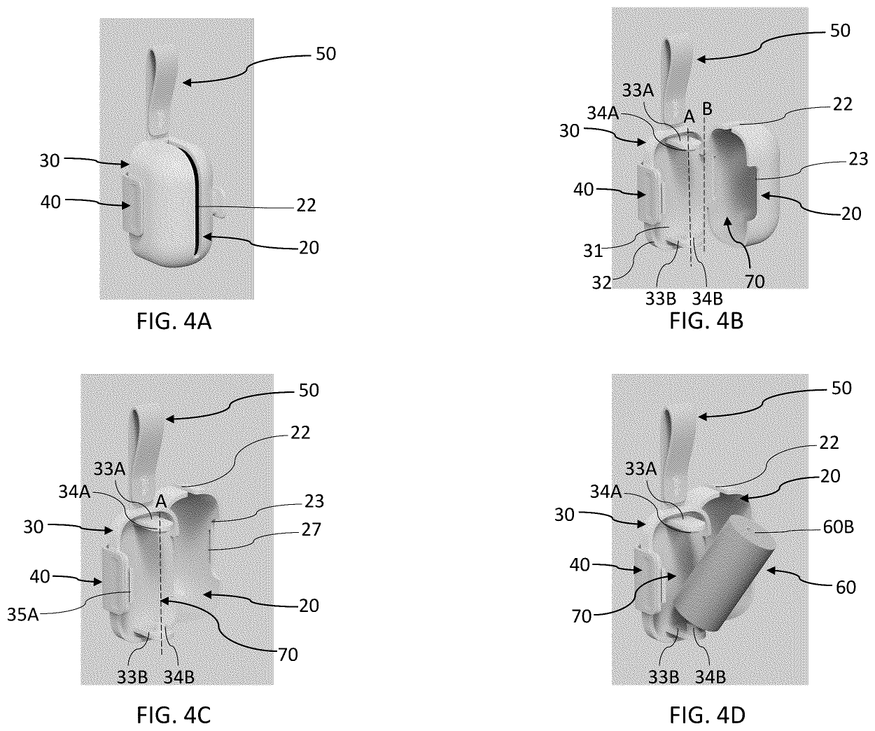

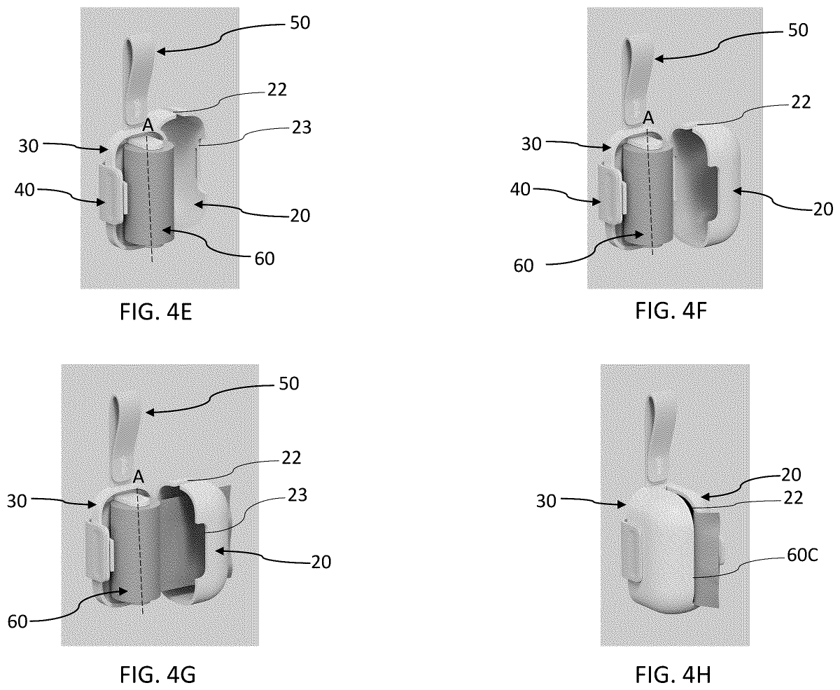

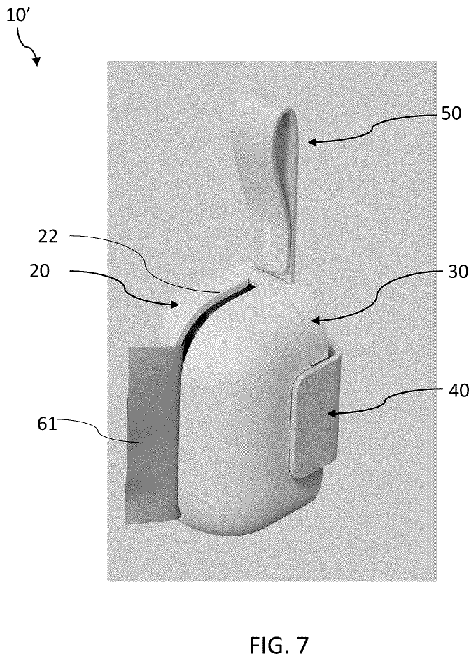

The depicted front casing portion 20 further includes features for engagement with the rear casing portion 30. Illustratively, the first side 21D includes a cutout 23 (FIG. 4B), while the second side 21E includes an aperture 24 and a tab 25. The reverse arrangement may also be contemplated. Other attachment configurations on the front casing portion 20 may be contemplated, for instance slots or grooves. In the shown case, a protrusion 26 (FIG. 1B) extends from the body 21, illustratively from the second side 21E. The protrusion 26 may, for instance, act as a handle or a grip for a user to hold the casing and open or close it, or as a bag stopper to assist in tearing a bag 61 from the roll 60. In other cases, the protrusion 26 may be omitted (see, for example, the alternate embodiment of the portable bag dispenser unit 10′ shown in FIG. 7, where like reference numerals refer to like elements). In a variant, the entirety of the front casing portion 20 is a monoblock, though this is only an option.

The rear casing portion 30 illustratively includes a body 31 (e.g., a plate body), a rim 32 extending partially about an outer perimeter of the body 31, and upper and lower supports 33A, 33B protruding from a plane of the body 31, the rim 32 and supports 33A, 33B extending away from a plane of the body 31 in a same direction (i.e., into the inner cavity 70). The rim 32 and supports 33A, 33B may be integral parts of the body 31. A first bag roll axle 34A extends downwardly from a bottom surface of the upper support 33A and a second bag roll axle 34B extends upwardly from an upper surface of the lower support 33B. The first and second bag roll axles 34A, 34B may be integral parts of the upper and lower supports 33A, 33B, respectively. The first and second bag roll axles 34A, 34B are axially aligned relative to a bag roll axis A and may serve as plain bearing for the bag roll 60 in the inner cavity 70. The first and second bag roll axles 34A, 34B may also be referred to as hubs, pivots, etc. In a variant, one or both of the axles 34A, 34B may have a frustoconical portion, to facilitate the positioning of a roll of bags thereon, with a top dome. Other shapes include cylindrical, for example.

Referring to FIGS. 2 and 4A-4D, exemplary attachment configurations between the rear casing portion 30 and front casing portion 20 are shown. As discussed above, the depicted front casing portion 20 is hingedly mounted to the rear casing portion 30. Illustratively, the depicted front casing portion 20 includes a cutout 23 on the first side 21D and an aperture 24 on the second side 21E. In addition, the depicted rear casing portion 30 includes a tab 35 extending from the rim 32 and alignable with the cutout 23 on the left side 21D of the front casing portion. On an opposite side of the rim 32 from the tab 35, a cutout 36 in the rim 32 is alignable with the tab 25. The tab 25 illustratively includes holes or recesses 25A in upper and lower edges thereof, and the cutout 36 includes posts or pegs 37 on opposite sides of the cutout 36 and aligned along a hinge axis B. The reverse arrangement or other arrangements are possible. The posts 37 are alignable and insertable into the holes 25A to form a hinged connection between the front casing portion 20 and the rear casing portion 30. The front casing portion 20 is thus pivotable relative to the rear casing portion 30 about the hinge axis B to expose the inner cavity 70 (see FIGS. 4A-4D). The cutout 23 may be engageable with the tab 35 to secure the front casing portion 20 to the rear casing portion 30 in a closed configuration of the casing, and disenable to allow the front casing portion 20 to pivot relative to the rear casing portion 30 to expose the inner cavity 70 in an opened configuration of the casing. The hinged connection between the front and rear casings 30 may be disengaged by removing the posts 37 from the holes 25A, thereby allowing the front casing portion 20 to be fully separated from the rear casing portion 30.

In some cases, the cutout 36 may interrupt the rim 32, as shown in FIG. 2. In other cases, the cutout 36 may be formed into the rim 32. In the shown case, a tongue 35A extends from the tab 35. As such, the front casing portion 20 is securable to the rear casing portion 30 by pivoting the front casing portion 20 relative to the rear casing portion 30 until the tab 35 is engaged with the cutout 23. In the depicted case, the tongue 35A may engage with the cutout 23, illustratively a groove 27 (see FIG. 4C) on an inner surface of the first side 21D adjacent to the cutout 23 to engage the tab 25 with the cutout 36. This may cause a captive engagement, relying on elastic deformation to connect or disconnect. Various retention means, such as hooks and slots, may be provided to secure the front casing portion 20 to the rear casing portion 30. Other attachment configurations may be contemplated.

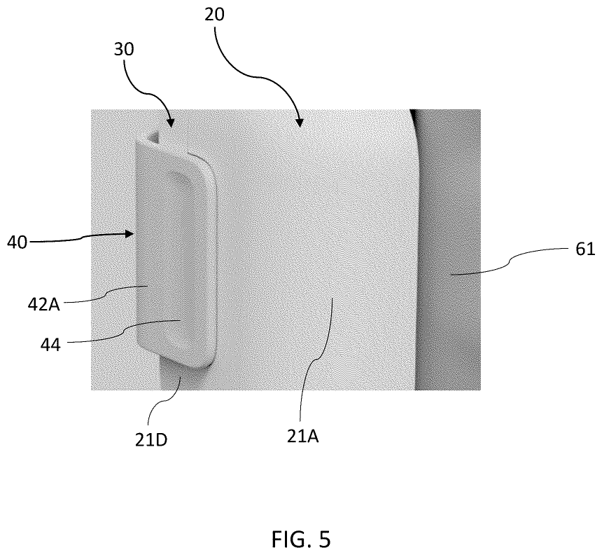

Referring to FIGS. 1A-1C, 2 and 5, an exemplary holder 40 is shown. The holder 40 may be configured for further securing the front casing portion 20 to the rear casing portion 30, as well as for interfacing the casing with the optional attachment 50. The holder 40 with its elasticity may be used in a strap-like manner, as explained below. The depicted holder 40 includes a base portion 41 with first and second side portions 42A, 42B extending from edges of the base portion 41, as an option. In the shown case, the holder 40 exhibits sufficient elastic deformation so that the side portions 42A, 42B, extending generally perpendicularly to the base portion 41, may deflect in either direction relative to the base portion 41, for instance to facilitate installation with the casing. Tabs 43A, 43B may extend inwardly from the first and second side portions 42A, 42B, respectively, and are configured to engage the casing. In particular, tab 43A is insertable through an aperture 35B in the tab 35 of the rear casing portion 30, while tab 43B is insertable through the aperture 24 in the front casing portion 20. The tabs 43A, 43B and apertures 35B, 24 may thus be correspondingly dimensioned for secure engagement. Other securing means between the holder 40 and the casing may be contemplated. In some cases, one or both of the side portions 42A, 42B may optionally include a recess 44 on an outer surface thereof, for instance to assist a user in gripping the holder 40 (see FIG. 5).

Referring to FIGS. 1A-1C, 2 and 3A, while optional, the attachment 50 may conveniently be used to attach the dispenser unit to a leash, to a belt, etc. Illustratively, the shown attachment 50 is a strap configured for securing the dispenser unit 10 to a ring 81 or handloop on a pet leash 80. The shown strap extends from a first end 51 operatively coupled to the holder 40 and a second, free end 52 removably attachable to the strap. In some cases, the first end 51 is removably coupled to the rear casing portion 30 (or alternatively to the holder 40), for instance via a snap mechanism, comolding, overmolding, gluing, etc. Other securing means may be contemplated, such as a button, a magnet, etc. In other cases, the first end 51 may be integrally formed with or non-removably coupled to the rear casing portion 30 or to the holder 40. The second end 52 may be removably attachable to the strap, illustratively to the first end 51. In the shown case, a protrusion 53, for instance a button, at the second end 52 is insertable through an aperture 54 at the first end 51 to form a loop to hang the dispensing unit 10 by the attachment 50. The protrusion 53 may thus protrude through the aperture 54 and create a grabbable grip or handle (see FIG. 1C). Other securing means for the strap (or other attachment 50) may be contemplated. Moreover, it is also considered to provide other attachment devices such as a handle or a spring-loaded clip, to allow the dispenser unit to be secured to another object. The holder 40 may be sufficient to secure the dispensing unit 10 to a leash, if one wants to secure the dispensing unit 10 to a leash.

Referring to FIGS. 3A-3D, a method for securing a portable bag dispensing unit 10 to an object such as a leash 80 is illustratively depicted. The dispensing unit 10 is brought adjacent the leash 80, with the holder 40 separated from the casing and the attachment 50, illustratively a strap, provided in an open configuration (see FIG. 3A, with the first end 51 separated from the second end). The strap is threaded through the ring 81 and moved to a closed configuration (e.g., the second end 52 fastened to the first end 51 via protrusion 53 engaging the aperture 54, see FIG. 3B). The holder 40 is positioned on an opposite side of the leash 80 from the casing, with the base portion 41 abutting the leash 80 and the side portions 42A, 42B straddling the leash 80 (see FIGS. 2 and 3B-3C). Tabs 43A, 43B are then inserted into corresponding apertures 35B, 24 to secure the holder 40 to the casing (see FIGS. 2 and 3C-3D). The portable bag dispensing unit 10 is thus secured to the leash 80 via the attachment 50 secured to the ring 81 and the leash 80 being trapped between the holder 40 and the rear casing portion 30. Other securing means may be contemplated. The free end 60C of the bag 60 may be passed through the dispensing opening 22 before or after attachment of the bag dispensing unit 10 on the leash 80.

With reference to FIG. 6, advantageously, the dispensing opening 22 may extend at least partially across the top 21B of the body 21. Illustratively, the dispensing opening 22 extends fully across the top 21B. As such, a user may be able to visually inspect the inner cavity 70 and see the inserted bag roll 60. The user may thus be able to estimate how many bags 61 remain on the bag roll 60 and prepare for its eventual replacement.

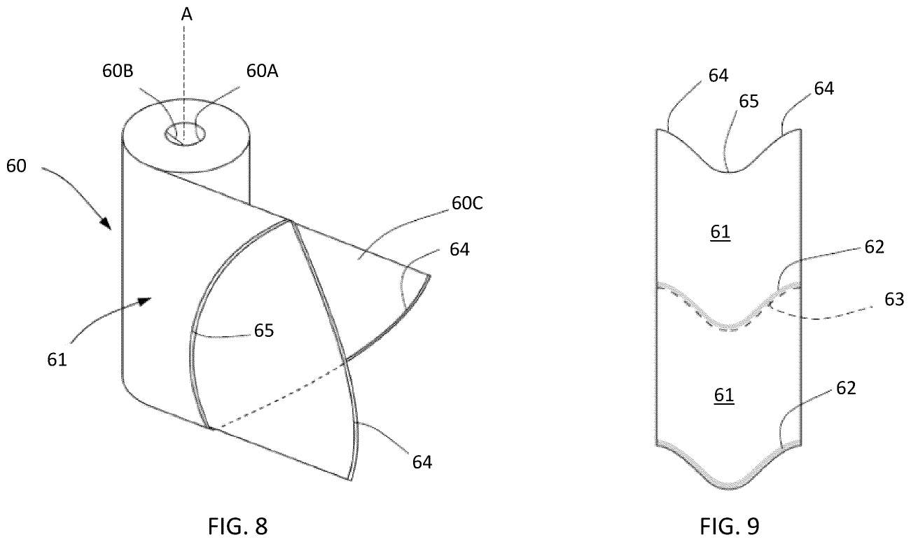

Referring concurrently to FIGS. 8 and 9, there is illustrated the bag roll 60, in accordance with one embodiment. The bag roll 60 has a tube 60A supporting a length of bags 61. The tube 60A is mounted about the bag roll axis A when the bag roll 60 is in the inner cavity 70. More particularly, the bag roll axles 34A, 34B are received in opposite ends of the tube 60A. Accordingly, the bag roll 60 may rotate about the bag roll axis A, with the bag roll axles 34A, 34B in an abutment relation with inner contact surface 60B. The tube 60A defines an interior of the bag roll 60. In an alternative embodiment, there is no distinct tube 60A, the bag roll 60 defining a hollow interior. The tube 60A may provide structural integrity.

The length of bags 61 is typically a length of a tubular material, in a sheet condition. The tubular material is perforated and sealed width-wise to define a plurality of bags 61 connected end to end, namely with the segment of bags between sets of a seam and a tearing line. The bags 61 are separated by a seam 62 made by the sealing of the tubular material. Accordingly, the seam 62 defines a bottom of the bag 61. In the roll, the seam 62 is adjacent to a tearing line 63 (resulting from the perforating), with the tearing line 63 being the joint between a pair of bags 61. Therefore, a bag 61 at a free end 60C of the bag roll 60 may be torn off a remainder of the bag roll 60 for use.

In the illustrated embodiment of FIG. 9, the free end 60C is defined by an open end of one of the bags 61 (i.e., opposite the seam 62), but could also be defined by the closed end of one of the bags 61 (i.e., with the seam 62).

The tubular sheet may be of any appropriate polymeric material, in one or multiple layers. Considering the odorous nature of some waste items that may be wrapped in the bag 61, a layer of an ethylene vinyl alcohol copolymer, among other possibilities, may be used. Any other suitable sheet polymer or sheet fibers could be used for the bag roll 60.

According to an embodiment, the tear-off strip 63 has a specific pattern to optimize the use of the bag 61. The pattern at the top open edge of the bag 61 (i.e., the edge opposite to the seam 62) defines a depression, illustrated by a pair of peaks 64 adjacent to the lateral sides of the bag 61, with the peaks 64 separated by a valley 65. Accordingly, the depression of the top open edge of the bag 61 is defined by a generally central portion thereof being lower than the peaks 64 adjacent to the lateral sides of the bag 61.

As the bag 61 is in the roll 60, the depression pattern of the top open edge results in a protrusion (a.k.a., nose, projection, convexity) projecting downwardly at the bottom closed edge of the bag 61, as the bags 61 are sequentially connected top to bottom in the roll 60. In this configuration of mating bottom edge and top edge of adjacent bags 61, there is no waste of plastic for each bag 61 that is perforated into the tubular sheet. More specifically, considering that the bag 61 of an embodiment has a uniform height, and considering the mating outlines of bags 61 interconnected end to end, there is no waste of bag material as there would be if the bag 61 had a straight bottom edge. However, it is also considered to have a straight bottom and top edges for the bags 61, with a cutout of the tubular material allowing the depression to be formed at the top open edge.

Although the peaks-and-valley depression edge of the bag 61 is shown with a sinusoidal outline in the illustrations, the peaks-and-valley edge may also have other outlines, such as a square waveform, a triangular waveform, among numerous other possibilities. The peaks 64 may also be offset vertically from one another. Moreover, the bag 61 may be rectangular in outline, or may have any other appropriate shape.

In order for the bag roll 60 to be compact, it may be folded on itself in a lengthwise direction. The fold lines are shown at 66, with two fold lines 66 being present. The fold lines are optional, but one or more of the fold lines 66 being possible.

Referring to FIG. 9, the specific shape of the bag 61 is ergonomically efficient when the bag 61 is used as a mitt for hand, such as when dog excrement is to be picked up. The thumb may lodge in a corner of the bag 61, while the remainder of the fingers are in the nose at the bottom of the bag 61 (i.e., central projection), thereby facilitating the manipulation and grasping of objects with the bag 61. Accordingly, typical suitable dimensions for the bag 61 are a width ranging between 7 inches and 12 inches, and the height of the lateral edges range between 8 inches and 12 inches. However, other dimensions may be used, depending on the application. These dimensions apply to rectangular shapes for the bag 61.

Therefore, when the bag 61 is used as a mitt (including for a rectangular bag), once the waste has been collected, the bag 61 is turned inside out with the waste being captured inside as a result of the operation. The bag 61 is then tied up, forming a knot in the manner described above.

Now that the portable bag dispenser unit 10 and the bag roll 60 storable therewithin have been described, a method for dispensing bags 61 from the portable bag dispenser unit 10, or like bag dispenser unit, is described.

Referring to FIGS. 4A-4H, the portable bag dispenser unit 10 may be empty and may require that a bag roll, such as bag roll 60, be inserted therein (see FIGS. 4A-4D). In one way to insert the bag roll 60, the front casing portion 20 is pivoted relative to the rear casing portion 30 about hinge axis B to reveal the inner cavity 70. Illustratively, the tongue 35A is disengaged from the groove 27 to allow the front casing portion 20 to pivot (see FIG. 2). In the shown case, the holder 40 is partially detached from the casing, with the first side portion 42A engaged with the rear casing portion 30 while the second side portion 42B is disengaged from the front casing portion 20. It is understood that the inner cavity 70 may be accessed by the reverse arrangement as well. The pivoting arrangement between the front casing portion 20 and the rear casing portion 30 may thus be said to selectively switch the casing between a closed and an open configuration, i.e., with the inner cavity 70 exposed in the open configuration. The bag roll 60 is mounted onto the bag roll axles 34A, 34B along the axis A (see FIGS. 4D-4E), with the inner contact surface engaging the bag roll axles 34A, 34B and the bag roll 60 rotatable about the axis A, and this may require some elastic deformation of the supports 33A and 33B. The front and rear casing portions 20, 30 are then operatively coupled (i.e., by pivoting the front casing portion 20 relative to the rear casing portion 30 relative to the hinge axis B until the tongue 35A reengages with the groove 27) to enclose the inner cavity 70 with the bag roll 60 secured therewithin (see FIGS. 4F-4H). Such operative coupling of the front and rear casing portions 20, 30 may be performed by pivoting the front casing portion 20 relative to the rear casing portion 30 relative to the hinge axis B until the tongue 35A reengages with the groove 27, as discussed above. Before enclosing the inner cavity 70, a free end 60C of the outermost bag 61 on the bag roll 60 may be inserted through the dispensing opening 22 in the front casing portion 20. The second side portion 42B may be reengaged with the front casing portion 20, such as by the tab 43B being reinserted into the aperture 24, optionally reattaching the dispenser unit 10 to the leash.

To dispense a bag 61 the bag roll 60, may be pulled out of the bag dispenser unit 10, through the dispensing opening 22, to unroll the bag 61 from the bag roll 60.

Depending on the configuration of the portable bag dispenser unit 10 and/or of the bag roll 60, the bag may be unfolded from a folded condition. A user may insert his/her hand in the bag and pick up waste with the hand shielded by the bag. The hand may be removed from the bag and tuning the bag inside out for the waste to be captured in the reversed bag.

After detaching the outermost bag 61, a free end 60C of the next bag 61 may now protrude from the dispensing opening 22, ready to be pulled out of the bag dispenser unit 10 at the next dispensing event.

The portable bag dispenser unit 10 may generally be described as having a casing having a front casing portion mounted to a rear casing portion to define an inner cavity therewithin for receiving a bag roll, the rear casing portion including a pair of axially-aligned bag roll axles along a bag roll axis for engaging an interior of the bag roll, the bag roll rotatable about the bag roll axis, an opening defined through the front casing portion for outletting a free end of the bag roll to dispense the bags; and a holder operatively coupled to the casing.

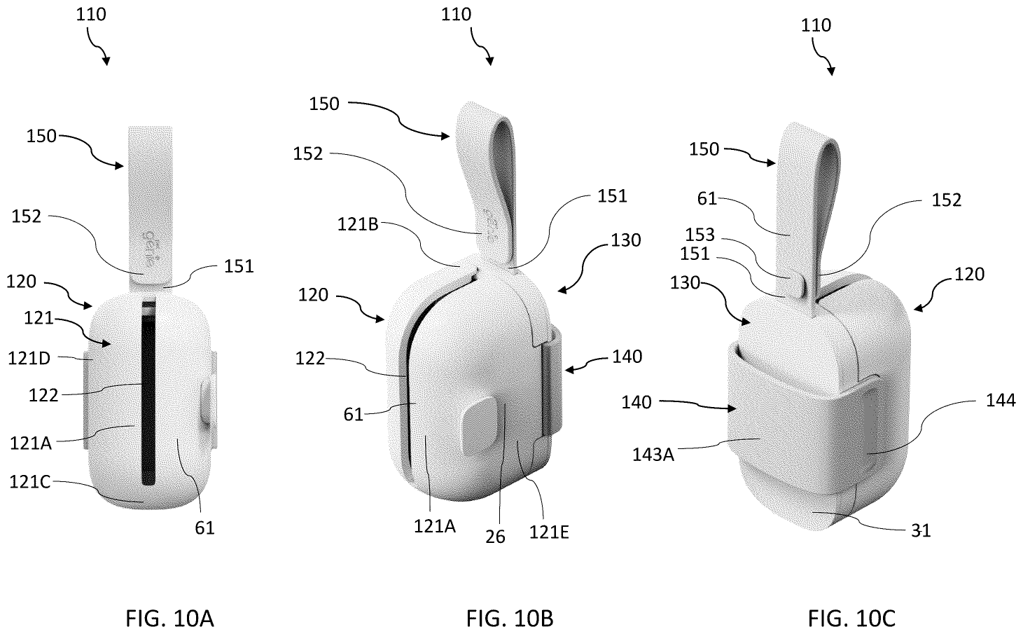

Referring now to FIGS. 10A-15C, there is shown an alternative portable bag dispenser unit 110 in accordance with the present disclosure. The portable bag dispenser unit 110 is used to dispense bags, such as bags from a bag roll. The portable bag dispenser unit 110 is said to be portable, in that it is relatively small and lightweight, and may have an attachment feature. The bag dispenser unit 110 is shown having a casing defined by a front casing portion 120 and a rear casing portion 130, and a holder 140 with an integrated attachment 150. The front and rear casing portions 120, 130 cooperate to define the casing to accommodate a bag roll (e.g., bag roll 60 shown in FIG. 8). The front casing portion 120 is hingedly mounted to the rear casing portion 130 to enable access to a hollow inner cavity 170 formed between the front casing portion 120 and rear casing portion 130. The front casing portion 120 and rear casing portion 130 are collectively referred to as the casing of the bag dispenser unit 110. When applicable, the various characteristics, options and alternatives of the bag dispenser unit 10 are also usable in the bag dispenser unit 110, and vice-versa, with like reference numerals referring to like features, though in the 100's (i.e., +100). For example, the front casing portion 20 in the bag dispenser unit 10 corresponds to the front casing portion 120 in the bag dispenser unit 110.

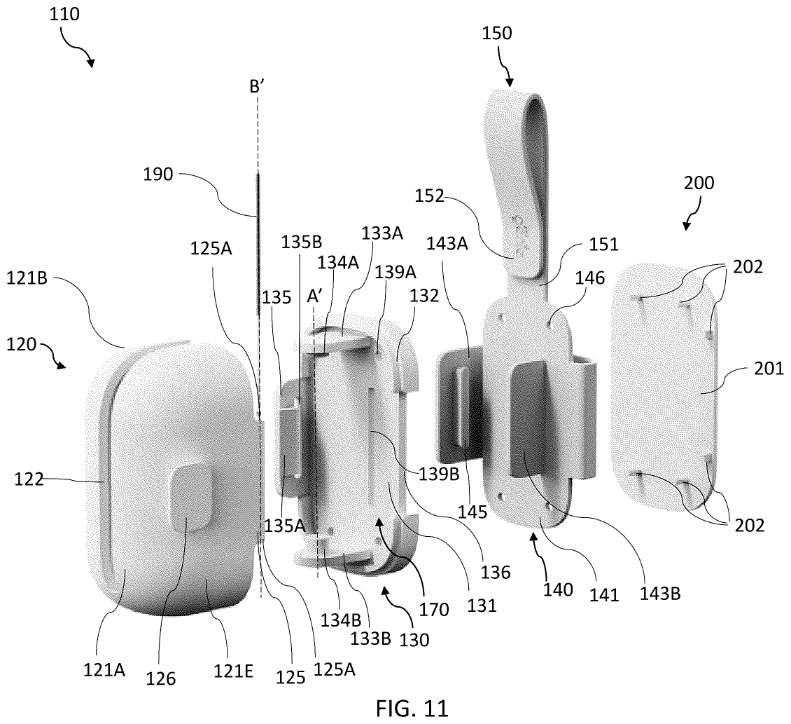

Referring to FIGS. 10A-10C and 11, the inner cavity 170 is sized so as to accommodate a bag roll (e.g., bag roll 60). In an embodiment, the front casing portion 120 is hingedly interconnected with the rear casing portion 130 via a pin 190 so as to provide access to the inner cavity 170 to optionally insert a bag roll into the bag dispenser unit 110. Other hinged connections between the front casing portion 120 and rear casing portion 130 may be contemplated. Illustratively, a rear cover 200 is provided to further couple the holder 140 to the casing, as will be discussed in further detail below. According to an embodiment, the front and rear casing portions 120, 130 are made of a plastic material with greater rigidity (e.g., a plastomer), while the holder 140 and attachment 150 are made of a plastic material with greater flexibility (e.g., an elastomer such as silicone rubber). Any other appropriate materials are also considered.

As shown in FIGS. 10A-10C, the front casing portion 120 has a body 121 with a front 121A, top 121B, bottom 121C, first side 121D and second side 121E, the body 121 for instance being bulbous. While the front casing portion 120 is described as having 121A, 121B, 121C, 121D and 121E, its surface may be continuous, i.e., edgeless, between such faces or sides, as illustrated in FIGS. 10A-10C A rear of the body 121 is open so as to engage with the rear casing portion 130. The front casing portion 120 has a dispensing opening 122 defined therein. Illustratively, the dispensing opening 122 has a slit-like shape extending across two faces of the body 121, the front 121A and top 121B, in a generally longitudinal direction, but it could be limited to a single face or may be more than two faces. If the dispensing opening 122 is a slit, it may be said that it lies in a plane concurrently with the bag roll axis A′. If the dispensing opening 122 is a slit, it may be said that it is parallel to the bag roll axis A′ and/or the hinge axis B′. Stated differently, it may be one or both of the long edges of the slit 122, or a midline, that may be coplanar and/or parallel as described above. In the shown case, the dispensing opening 122 is alignable with a leash when the dispensing unit is attached to the leash (e.g., leash 80 in FIGS. 3A-3D). Other appropriate shapes may be used for the dispensing opening 122. It is considered to shape the opening 122 with ornamental outlines. As observed from FIGS. 10A-10B, the opening 122 is a relatively narrow opening, i.e., wide enough to allow individual bags of the bag roll to pass therethrough but narrow enough to prevent the bag roll itself from passing therethrough. The depicted opening 122 generally bisects the front 121A, although non-symmetrical locations for the opening 122 may be contemplated. The depicted opening 122 optionally extends from an uppermost portion of the top 121B and terminates at a lower end of the front 121A. As such, the opening 122 may provide a view inside the inner cavity 170 and of the bag roll.

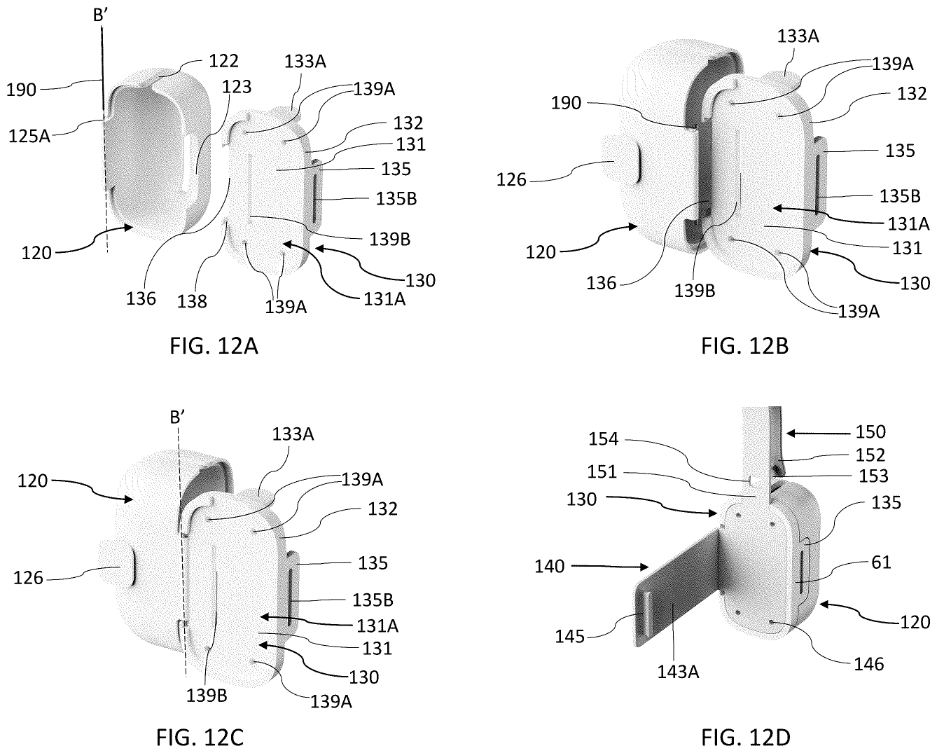

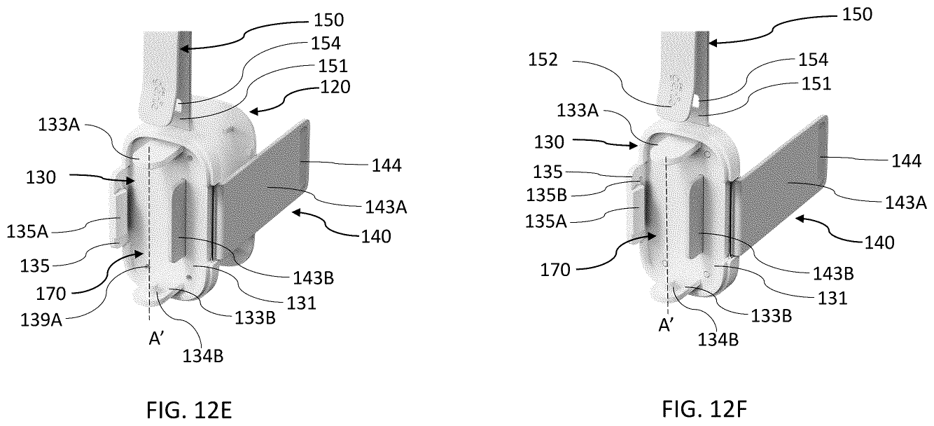

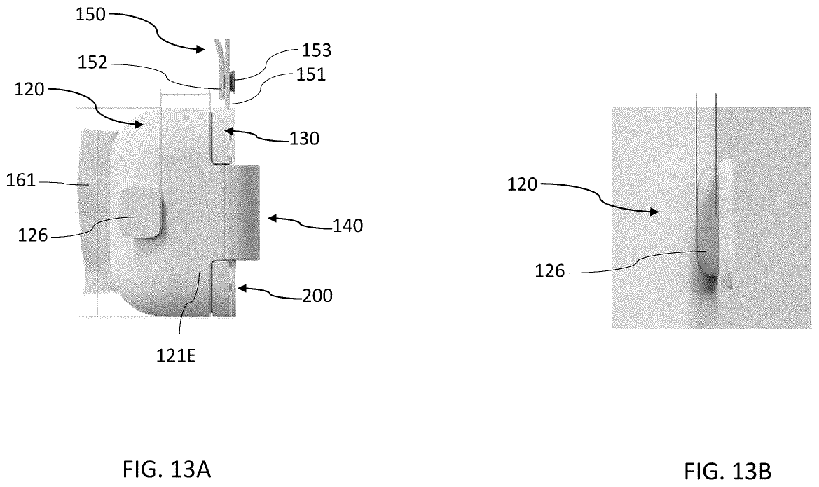

The depicted front casing portion 120 further includes features for engagement with the rear casing portion 130. Illustratively, the first side 121D includes a cutout 123 (FIG. 12A), while the second side 21E includes a tab 125. The reverse arrangement may also be contemplated. Other attachment configurations on the front casing portion 120 may be contemplated, for instance slots or grooves. In the shown case, a protrusion 126 (FIG. 12B-12C) extends from the body 121, illustratively from the second side 121E (see FIGS. 13A-13B). The protrusion 126 may, for instance, act as a handle or a grip for a user to hold the casing and open or close it, or as a bag stopper to assist in tearing a bag 161 from the bag roll. In other cases, the protrusion 126 may be omitted. In a variant, the entirety of the front casing portion 120 is a monoblock, though this is only an option.

The rear casing portion 130 illustratively includes a body 131 (e.g., a plate body), a rim 132 extending partially about an outer perimeter of the body 131, and upper and lower supports 133A, 133B protruding from a plane of the body 131, the rim 132 and supports 133A, 133B extending away from a plane of the body 131 in a same direction (i.e., into the inner cavity 170). The rim 132 illustratively extends into the opposite direction (i.e., away from the inner cavity 170) to define an outer cavity 131A on an opposite or rear side of the body 131 (see FIGS. 12A-12C), as will be discussed in further detail below. The rim 132 and supports 133A, 133B may be integral parts of the body 131. A first bag roll axle 134A extends downwardly from a bottom surface of the upper support 133A and a second bag roll axle 134B extends upwardly from an upper surface of the lower support 133B. The first and second bag roll axles 134A, 134B may be integral parts of the upper and lower supports 133A, 133B, respectively. The first and second bag roll axles 134A, 134B are axially aligned relative to a bag roll axis A′ and may serve as plain bearing for the bag roll in the inner cavity 170. The first and second bag roll axles 134A, 134B may also be referred to as hubs, pivots, etc. In a variant, one or both of the axles 134A, 134B may have a frustoconical portion, to facilitate the positioning of a roll of bags thereon, with a top dome. Other shapes include cylindrical, for example.

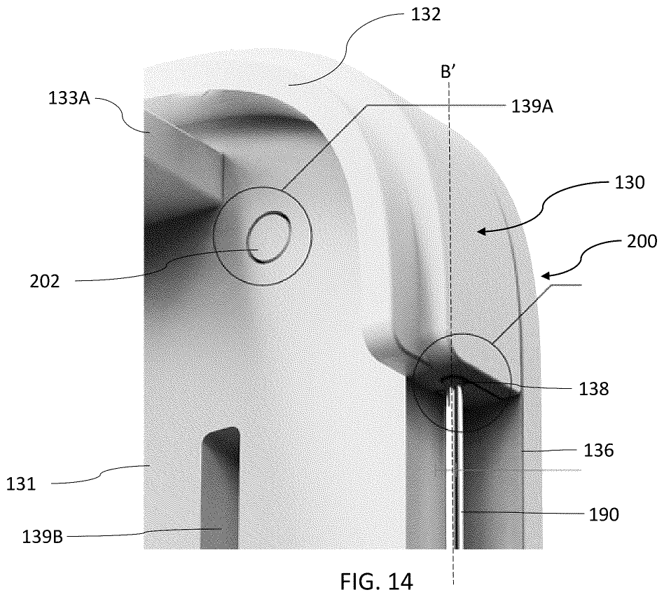

Referring to FIGS. 11-12C, exemplary attachment configurations between the rear casing portion 130 and front casing portion 120 are shown. As discussed above, the depicted front casing portion 120 is hingedly mounted to the rear casing portion 130. Illustratively, the depicted front casing portion 120 includes a cutout 123 on the first side 121D. In addition, the depicted rear casing portion 130 includes a tab 135 extending from the rim 132 and alignable with the cutout 123 on the left side 121D of the front casing portion. On an opposite side of the rim 132 from the tab 135, a cutout 136 in the rim 132 is alignable with the tab 125. The tab 125 illustratively includes a hole 125A extending through the tab 125 between upper and lower edges thereof along a hinge axis B′, and the cutout 136 includes aperture 138 on opposite sides of the cutout 136 aligned along a hinge axis B′. The reverse arrangement or other arrangements are possible. The pin 190 is alignable with and insertable through the hole 125A and the apertures 138 (see FIG. 14) to form a hinged connection between the front casing portion 120 and the rear casing portion 130. The front casing portion 120 is thus pivotable relative to the rear casing portion 130 about the hinge axis B′ to expose the inner cavity 170. The cutout 123 may be engageable with the tab 135 to secure the front casing portion 120 to the rear casing portion 130 in a closed configuration of the casing, and disenable to allow the front casing portion 120 to pivot relative to the rear casing portion 130 to expose the inner cavity 170 in an opened configuration of the casing. The hinged connection between the front and rear casings 130 may be disengaged by removing the pin 190 from the hole 125A and apertures 138, thereby allowing the front casing portion 120 to be fully separated from the rear casing portion 130.

In some cases, the cutout 136 may interrupt the rim 132, as shown in FIG. 11. In other cases, the cutout 136 may be formed into the rim 132. In the shown case, a tongue 135A extends from the tab 135. As such, the front casing portion 120 is securable to the rear casing portion 130 by pivoting the front casing portion 120 relative to the rear casing portion 130 until the tab 135 is engaged with the cutout 123. In the depicted case, the tongue 135A may engage with the cutout 123, illustratively a groove (e.g., groove 27 in FIG. 4C) on an inner surface of the first side 121D adjacent to the cutout 123 to engage the tab 125 with the cutout 136. This may cause a captive engagement, relying on elastic deformation to connect or disconnect. Various retention means, such as hooks and slots, may be provided to secure the front casing portion 120 to the rear casing portion 130. Other attachment configurations may be contemplated. The depicted rear casing portion 130 further includes holes 139A, illustratively four holes 139, and a slit 139B, extending through the body 131. The number and positioning of the holes 139A and slit 139B may vary and corresponds to a number and positioning of corresponding features in the holder 140 and rear cover 200, as will be discussed in further detail below.

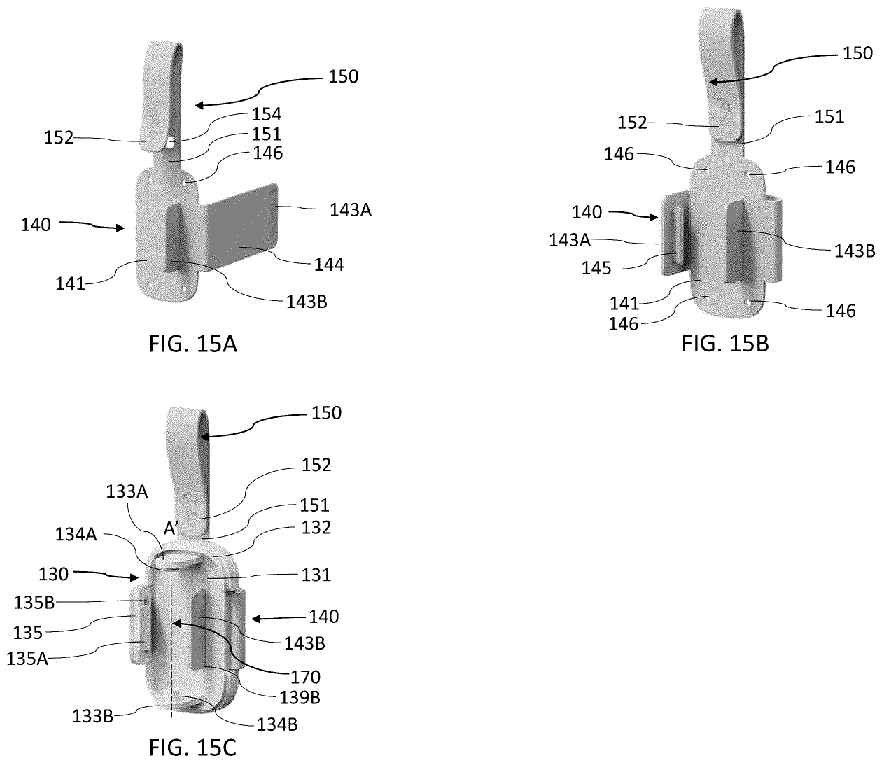

Referring to FIGS. 11 and 15A-15C, an exemplary holder 140 and attachment 150 is shown. In the shown case, the holder 140 is integrally connected to the attachment 150. Non-integral holders and attachments may be contemplated, for instance holder 40 and attachment 50 shown in FIG. 2. However, the arrangement shown is such that a single piece of elastomer is used to define both the holder 140 and the attachment 150. The holder 140 may be configured for further securing the front casing portion 120 to the rear casing portion 130, as well as for interfacing the casing with the attachment 150. The holder 140 with its elasticity may be used in a strap-like manner, as explained below. The depicted holder 140 includes a body 141. In the shown case, the holder 140 exhibits a sufficient degree of elastic deformation to be capable of deflecting in various directions, for instance, to facilitate installation with the casing. A pair of tabs 143A, 143B extend from the body 141 and are configured to engage the casing. In particular, tab 143A extends from a side edge of the body 141 and is configured for wrapping around a rear of the body 141 and being inserted through an aperture 135B in the tab 135 of the rear casing portion 130, while tab 143B extends from a front surface of the body 141 and is insertable through the slit 139B of the rear casing portion 130. Tab 143A therefore extends between a first end coupled to an edge of the holder 140 at a first side of the bag dispenser unit and a second end couplable to the rear casing portion 130 at a second side of the bag dispenser unit 110 to form a loop at a rear of the bag dispenser unit 110. The tabs 143A, 143B, aperture 135B, and slit 139B may thus be correspondingly dimensioned for secure engagement. As shown in FIGS. 12C-12D, the holder 140 is illustratively received in the outer cavity 131A of the rear casing portion 130. The holder 140 and outer cavity 131A may thus be dimensioned to allow this engagement. Other securing means between the holder 140 and the casing may be contemplated. In the shown case, the tab 143A includes a recess 144 on an outer surface thereof, for instance, to assist a user in gripping the holder 140 (see FIG. 10C). The body 141 further includes holes 146 extending therethrough, illustratively four holes 146 positioned to align with the holes 139A in the rear casing portion 130. Other numbers of holes 146 may be contemplated.

Referring to FIGS. 10A-10C and 15A-15C, the depicted attachment 150 may conveniently be used to attach the dispenser unit 110 to a leash, to a belt, etc. Illustratively, the shown attachment 150 is a strap integrally formed with the holder 140 and extending from a top edge of the holder 140. The attachment 150 may be configured for securing the dispenser unit 110 to a ring or handloop on a pet leash (e.g., ring 81 on pet leash 80 of FIGS. 3A-3D). The shown strap extends from a first end 151 integrally formed with the holder 140 and a second, free end 152 removably attachable to the strap. The second end 152 may be removably attachable to the strap, illustratively to the first end 151. In the shown case, a protrusion 153, for instance a button, at the second end 152 is insertable through an aperture 154 at the first end 151 to form a loop to hang the dispensing unit 110 by the attachment 150. The protrusion 153 may thus protrude through the aperture 154 and create a grabbable grip or handle (see FIG. 10C). Other securing means for the strap (or other attachment 150) may be contemplated.

Referring to FIGS. 15A-15C, a method for securing the holder 140 and attachment 150 to the rear casing portion 130 is shown. The first tab 143A is wrapped around the rear of the body 141 so that it protrudes in a forward direction (i.e., towards the rear casing portion 130) from an opposite edge of the body 141 from the first end of the first tab 143A. The tab 143A then engages the tab 135 in the rear casing portion 130. Illustratively, an insert 145 extending from the tab 135 is aligned with and inserted through the aperture 135B in the tab 135. In addition the second tab 143B is aligned with and inserted through the slit 139B. Other attachment configurations may be contemplated.

Referring to FIGS. 11, 13A and 14, an exemplary rear cover 200 is shown. The rear cover 200 includes a body 201 with posts 202 extending from a front face of the body 201. The posts 202, illustratively four posts, are arranged so as to align with the holes 139A, 146 in the rear casing portion 130 and holder 140, respectively. As such, the rear cover 200 is secured to the dispensing unit by abutting the body 201 against a rear face of the holder body 141 and inserting the posts 202 through the holes 139A, 146. The first tab 143A is then wrapped around a rear of the rear cover 200 before engaging the tab 135. The rear cover 200 is optional, but contributes to the securing of the holder 140 and attachment 150 to a remainder of the bag dispenser unit 110.

Referring to FIGS. 12A-12F, the above-described securing of the front casing portion 120 to the rear casing portion 130, and of the holder 140 to the rear casing portion 130 are shown. In the shown case, the front casing portion 120 is secured to the rear casing portion 130 prior to the holder being secured to rear casing portion 130. It is understood that the reverse order may be contemplated as well. Once assembled, the dispensing unit 110 can be brought adjacent a leash (e.g., leash 80 of FIGS. 3A-3D) or object to which the dispensing unit 110 is to be attached. Dispensing unit 110 can be attached to the object by way of attachment 150, as described above. Additionally or alternatively, the first tab 143A can wrap around the object (i.e., trapping the object between the rear cover 200 and the first tab 143A) prior to securing the first tab 143A to the tab 135.

With reference to FIGS. 11 and 13A, advantageously, the dispensing opening 122 may extend at least partially across the top 121B of the body 121. Illustratively, the dispensing opening 122 extends fully across the top 121B. As such, a user may be able to visually inspect the inner cavity 70 and see the inserted bag roll. The user may thus be able to estimate how many bags 161 remain on the bag roll and prepare for its eventual replacement. As discussed above, the dispensing opening 122 is sized so that a bag 161 can be pulled therethrough, without removing the entire bag roll.

A method for dispensing bags 161 from the portable bag dispense unit 110 may be performed in the same manner as described above with regards to FIGS. 4A-4H. The portable bag dispenser unit 110 may be empty and may require that a bag roll be inserted therein. In one way to insert the bag roll, the front casing portion 120 is pivoted relative to the rear casing portion 130 about hinge axis B′ to reveal the inner cavity 170 (see FIGS. 12C and 12E). Illustratively, the tongue 135A is disengaged from the cutout 123 to allow the front casing portion 120 to pivot. The holder 140 may be partially detached from the casing, with the first tab 143A disengaged from the tab 135 while the second tab 143B remains engaged with the slit 139B. It is understood that the inner cavity 170 may be accessed by the reverse arrangement as well. The pivoting arrangement between the front casing portion 120 and the rear casing portion 130 may thus be said to selectively switch the casing between a closed and an open configuration, i.e., with the inner cavity 170 exposed in the open configuration. The bag roll is mounted onto the bag roll axles 134A, 134B along the axis A′, with the inner contact surface engaging the bag roll axles 134A, 134B and the bag roll rotatable about the axis A′, and this may require some elastic deformation of the supports 133A, 133B. The front and rear casing portions 120, 130 are then operatively coupled (i.e., by pivoting the front casing portion 120 relative to the rear casing portion 130 relative to the hinge axis B′ until the tongue 135A reengages with the cutout 123) to enclose the inner cavity 170 with the bag roll secured therewithin. Such operative coupling of the front and rear casing portions 120, 130 may be performed by pivoting the front casing portion 120 relative to the rear casing portion 130 relative to the hinge axis B′ until the tongue 135A reengages with the cutout 123, as discussed above. Before enclosing the inner cavity 170, a free end 1 of the outermost bag 161 on the bag roll may be inserted through the dispensing opening 122 in the front casing portion 120. The first tab 143A may be reengaged with the rear casing portion 130, such as by the insert 145 being reinserted into the aperture 135B, optionally reattaching the dispenser unit 110 to the leash or other like object.

To dispense a bag 161 from the bag roll, the bag 161 may be pulled out of the bag dispenser unit 110, through the dispensing opening 122, to unroll the bag 161 from the bag roll.

Depending on the configuration of the portable bag dispenser unit 110 and/or of the bag roll, the bag 161 may be unfolded from a folded condition. A user may insert his/her hand in the bag and pick up waste with the hand shielded by the bag. The hand may be removed from the bag and tuning the bag inside out for the waste to be captured in the reversed bag.

After detaching the outermost bag 161, a free end of the next bag 161 may now protrude from the dispensing opening 122, ready to be pulled out of the bag dispenser unit 110 at the next dispensing event.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A bag dispenser unit for dispensing bags, comprising:
a casing having a front casing portion mounted to a rear casing portion to define an inner cavity therewithin for receiving a bag roll, the rear casing portion including a pair of axially-aligned bag roll axles along a bag roll axis for engaging an interior of the bag roll, the bag roll rotatable about the bag roll axis, an opening defined through the front casing portion for outletting a free end of the bag roll to dispense the bags; and
a holder operatively coupled to the casing.

2. The bag dispenser unit as defined in claim 1, further comprising a strap operatively coupled to the casing at a first strap end and having a fastener disposed at a second strap end.

3. The bag dispenser unit as defined in claim 2, wherein the fastener is a snap fastener.

4. The bag dispenser unit as defined in claim 2, wherein the casing is operatively couplable to a pet leash.

5. The bag dispenser unit as defined in claim 4, wherein the strap is configured to engage a ring on the pet leash and the holder is configured to retain the casing against the pet leash.

6. The bag dispenser unit as defined in claim 2, wherein the strap is integrally formed with the holder.

7. The bag dispenser unit as defined in claim 1, wherein the opening extends at least partially across a top surface of the front casing portion to at least partially expose the bag roll inside the inner cavity.

8. The bag dispenser unit according to claim 1, wherein the front casing portion is hingedly mounted to the rear casing portion.

9. The bag dispenser unit according to claim 1, wherein the holder is removably attachable to the front casing portion on a first side of the bag dispenser unit and to the rear casing portion on a second side of the bag dispenser unit opposite the first side.

10. The bag dispenser unit according to claim 1, further comprising a rear cover removable attachable to the holder.

11. The bag dispenser unit according to claim 10, wherein the rear cover includes posts protruding from a surface thereof, the posts alignable and insertable through corresponding holes through a body of the holder and a body of the rear casing portion.

12. The bag dispenser unit according to claim 1, wherein the holder includes a tab having a first end coupled to an edge of the holder at a first side of the bag dispenser unit and a second end coupleable to the rear casing portion at a second end of the bag dispenser unit to form a loop at a rear of the bag dispenser unit.

13. A method for dispensing bags from a bag dispenser unit, comprising:
grasping a bag from a bag roll inside the bag dispenser unit via an opening of the bag dispenser unit, the opening extending across an outer surface of the bag dispenser unit and configured for allowing visual inspection of the bag roll inside the bag dispenser unit;
pulling the bag out of the bag dispenser unit to unroll the bag from the bag roll; and
detaching the bag from the bag roll.

14. The method according to claim 13, further including unfolding the bag from a folded condition.

15. The method according to claim 13, further including inserting a hand in the bag and picking up waste with the hand shielded by the bag.

16. The method according to claim 15, further including removing the hand from the bag and tuning the bag inside out for the waste to be captured in the inside out bag.

17. The method according to claim 13, further comprising visually inspecting the inside of the bag dispenser unit, via the opening of the bag dispenser unit, to determine a number of bags remaining on the bag roll.

18. The method according to claim 13, further comprising:
disengaging a front casing portion of the bag dispenser unit from a rear casing portion of the bag dispenser unit;
inserting the bag roll within the bag dispenser unit by engaging the bag roll with a bag roll axles of the rear casing portion; and
engaging the front casing portion to the rear casing portion.

19. The method according to claim 18, wherein disengaging the front casing portion from the rear casing portion and engaging the front casing portion to the rear casing portion each include pivoting the front casing portion relative to the rear casing portion about a hinge axis defined through a hinged connection between the front casing portion and the rear casing portion.

20. The method according to claim 18, further comprising securing the bag dispenser unit to a leash by securing a strap operatively coupled to the bag dispenser unit to a ring on the leash.
